(19) United States
(12) Patent Application Publication
(10) Pub. No.: US 2008/0278003 A1
(43) Pub. Date: Nov. 13, 2008

(54) HIGH EFFICIENCY ALTERNATIVE/RENEWABLE POWERED UPS SYSTEM

(75) Inventors: Jack H. Pouchet, Foothill Ranch, CA (US); Peter A. Panfil, Columbus, OH (US); Jeffrey M. Powell, Lewis Center, OH (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: LIEBERT CORPORATION, Columbus, OH (US)

(21) Appl. No.: 11/746,080

(22) Filed: May 9, 2007

(51) Int. Cl. H02J 7/00

(52) U.S. Cl. 307/66

(57) ABSTRACT

The disclosure provides an efficient alternative energy uninterruptible power supply (UPS) system having a main first source of power coupled to an electrical load, comprising: a second source of power from stored energy coupled to the electrical load, the second source being adapted to supplement the first source and condition the power from the stored energy to predetermined conditions for the electrical load; an automatic transfer switch (ATS) coupled between the first source and the second source and adapted to control the first source coupling to the electrical load when the first source power is noncompliant with predetermined conditions for the electrical load; and a source of alternative energy coupled downstream of the ATS to the second source, the electrical load, or a combination thereof, wherein the source of alternative energy comprises a source of direct current (DC) power.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to power systems; and more specifically relate to power systems using a variety of energy sources.

2. Description of the Related Art

For decades, alternative energy sources have been considered in supplementing power provided by utility companies for electrical loads. Such alternative energy sources include solar energy, geo-thermal energy, wind energy, hydro energy, fuel cells, biomass and gas generated therefrom, tidal energy, and the like. To produce the necessary voltage and/or current, multiple arrays of panels, levies, dams, wind turbines, fuel cells, and so forth can be connected in series, in parallel or both, according to the needs of the system. However, the costs per kilowatt of power have commercially retarded the acceptance of alternative energy usage. For those systems in which alternative energy is used, any increase in efficiency can have significant benefits. A typical alternating current (AC) system uses various rectifiers, inverters, and other equipment to convert, filter, and adapt the alternative energy into a suitable voltage, frequency, and phase angle to synchronize with the associated utility power grid to provide power to an electrical load. The various conversions yield power losses and other inefficiencies. While significant efforts have been made in developing higher efficiency sources, additional attention can be made toward the various inter-connections and energy conversions between the alternative energy sources, the main utility supply, and the electrical load.

FIG. 1 is a schematic of a typical utility AC power system with a supplemental alternative energy source. The power system 2 includes a utility AC power source 4 for providing power from a power grid to an automatic transfer switch (ATS) 6. The ATS can disconnect the AC power source 4 when the AC power is not present or noncompliant with predetermined conditions for the electrical load. When other sources of power are available, the ATS can switch to the other sources. An ATS output can be connected to the electrical load 10 through a bypass switch 8. For some electrical loads, such as mission critical electrical loads, include data centers, control systems, hospitals and medical facilities, and other sensitive areas, the AC power is routinely directed through an uninterruptible power supply (UPS) 12 to condition the power and/or supplement power prior to the electrical load 10. The UPS 12 typical converts the AC power into a DC form through a rectifier and then converts the DC form into a simulated AC form through an inverter to provide the conditioned power to the electrical load 10. In some situations, the UPS itself can provide power for a limited time through a battery provided with the UPS. The bypass switch 8 is normally closed except when performing maintenance and other functions where the UPS is unavailable.

A generator 14 can supply power as another input to the ATS. The generator 14 typically is a standby generator that is operational only for power outages or when the utility power is otherwise noncompliant with prescribed conditions needed for the electrical load 10. The ATS can disconnect the AC power source 4 and provide input to a controller (not shown) to start up the generator 14.

The AC power system 2 can further include an alternative energy source 16. The alternative energy source 16 typically generates a direct current (DC) form of power. The DC power is provided to a controller 17, such as a “maximum power point tracker” (MPPT). The MPPT is a device or circuit that optimizes the voltage/current from the alternative energy source 16 to fit better the DC power into a form suitable for a DC to AC inverter, and to assist in synchronizing the voltage frequency and phases to the utility AC power grid. The inverter is sometimes referred to as a “grid-tie” inverter 18 that converts the DC power into the AC power for the utility grid. However, the conversion process from DC to AC power for the utility grid inherently causes power losses, which are believed to be about 92-95%.

A utility control 20, such as a relay, can open and close the alternative energy source circuit to the utility grid, depending upon the condition of the power from the inverter 18 and/or MPPT controller 17, if present. The system can include an additional ATS 22 located between the inverter 18 and the relay 20 to further control the delivery of the load from the alternative energy source 16.

Upon loss of AC power in a traditional utility power/alternative energy system, the utility connected grid-tie inverter 18 is forced off line as generally required by “anti-islanding” regulations to avoid generating power into a downed utility grid for safety precautions. Despite the availability of the alternative energy power for the electrical load, such as a data center, this alternative energy power is unavailable to the electrical load until the utility power returns. The loss of utility power can extend for hours and sometimes days, depending on the severity of the condition.

Further, with such typical systems, the power from the alternative energy source 16 that was converted from DC to AC by the grid-tie inverter 18 is afterwards routed through the UPS 12 that reconverts the AC power to DC power and then to a simulated AC waveform. The multiple conversions result in further loss of efficiency. It is estimated that about 10% of the energy is lost by the double conversion through the grid-tie inverter and then through the conversion through the UPS. For large power systems, this loss of power can be a significant amount.

Therefore, there remains a need for an improved power system that uses alternative sources of energy in a more efficient manner.

### BRIEF SUMMARY OF THE INVENTION

The present invention provides an increased efficiency and generally lower system cost and complexity by eliminating the grid-tie inverter and providing a different configuration than the typical power system. The invention radically departs from the standard design criteria by recognizing certain well-established components can be redirected or eliminated, and still maintain high integrity power to the ultimate electrical load.

In at least one embodiment, the disclosure provides an efficient alternative energy uninterruptible power supply (UPS) system having a main first source of power coupled to an electrical load, comprising: a second source of power from stored energy coupled to the electrical load, the second source being adapted to supplement the first source and condition the power from the stored energy to predetermined conditions for the electrical load, the second source having an inverter adapted to change a direct current (DC) to an alternating current (AC); an automatic transfer switch (ATS) coupled between the first source and the second source and adapted to control the first source coupling to the electrical load when the first source power is noncompliant with predetermined conditions for the electrical load; and a source of alternative energy coupled to an input to the inverter of the second source, wherein the source of alternative energy comprises a source of direct current (DC) power and comprises solar energy, thermal energy, geo-thermal energy, wind energy, hydroelectric energy, fuel cell energy, biomass energy, tidal energy, or a combination thereof.

The disclosure also provides an efficient alternative energy uninterruptible power supply (UPS) system having a main first source of power coupled to an electrical load, comprising: a second source of power from stored energy coupled to the electrical load, the second source being adapted to supplement the first source and condition the power from the stored energy to predetermined conditions for the electrical load; an automatic transfer switch (ATS) coupled between the first source and the second source and adapted to control the first source coupling to the electrical load when the first source power is noncompliant with predetermined conditions for the electrical load; and a source of alternative energy coupled downstream of the ATS to the second source, the electrical load, or a combination thereof, wherein the source of alternative energy comprises a source of direct current (DC) power.

### BRIEF DESCRIPTION OF THE SEVERAL VIEWS OF THE DRAWINGS

A more particular description, briefly summarized above, may be had by reference to the embodiments illustrated in the appended drawings, forming part of the present specification and described herein. It is to be noted, however, that the appended drawings illustrate only some embodiments described herein and are therefore not to be considered limiting of the disclosure's scope, in that there can be other equally effective embodiments.

FIG. 1 is an exemplary schematic of a typical utility AC power system with a supplemental alternative energy source.

FIG. 2 is a schematic of an exemplary embodiment of the present invention having a first and second source of energy coupled to an alternative energy source, providing input downstream of a rectifier in the second source.

FIG. 3 is a schematic of another embodiment similar to FIG. 2 providing input to the second source of energy.

FIG. 4 is a schematic of another embodiment having a DC feed to an electrical load.

FIG. 5 is a schematic of the exemplary embodiment of FIG. 2 with additional details and components.

### DETAILED DESCRIPTION

In general, the system includes several main building blocks in one or more of the embodiments disclosed. In addition to the utility power supply as a first or main source of power, the system can include: a second source of power, such as an uninterruptible power supply (UPS); associated switch gear and/or downstream interface circuits associated with the second source; upstream AC switch gear between the first and second source; and in some embodiments, an upstream generator and control interface that delays or regulates the generator operation. The system can provide additional usage of the alternative energy source and/or the second source without necessitating starting up the generator when the first source power is not present or outside acceptable conditions for such power. It is believed that the system can reduce the cost of installation by eliminating various components, particularly the grid-tie inverter, and in some embodiments, the MPPT controller. The system can also provide alternative energy power independent of the upstream AC utility power source and provide more assurance to mission critical installations of continued available power.

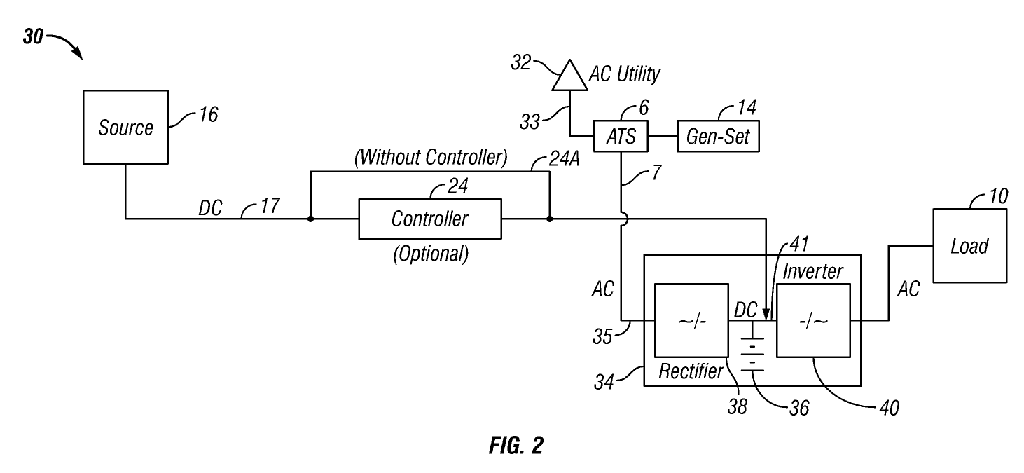

The present invention provides a series of possible power paths within the overall scope of the invention as described in more detail in FIGS. 2-5. In at least one embodiment, the system eliminates the utility interconnect controls that lead to the anti-islanding shutdown of the alternative energy source. It is possible that such controls can be avoided, because the system is protected and isolated from generating power into a downed AC utility grid by the automatic transfer switch (ATS) disposed in a different position in the system than is customary and expected. Eliminating the utility interconnect enables the system to provide power to the electrical load even when the main utility source is being serviced. Various interlocking controls are built into the system that can utilize features found within the second source, such as the UPS, to protect against under and over voltage in current conditions, faults, short-circuits, and temporary loss of the alternative power source or sources. These controls are not described in detail, as it is believed such would be known to those with ordinary skill in the art given the guidance of the disclosure contained herein. In some embodiments, the interlocking controls can include day, week and other temporal features and backup to help avoid an intentional or accidental clock reset when such temporal features are used in the system. Further, the system can provide manual override controls so that one or more single components can be isolated from the balance of the system for service work and other efforts. Still further, the system can include voltage and current detectors at various points in the system, so that the system can determine if appropriate prior conditions are being met to provide reliable power to the downstream second source, electrical load, or a combination thereof from either the alternative energy source or the AC power source. The voltage and/or current detectors can be used to determine the level of alternative energy power available to the system and can be monitored in real time. These values can be compared against the second source of power and any loading thereon to determine if there is sufficient power available to power the downstream electrical load in the event of a loss of the primary AC power source. In the event that sufficient alternative energy power is available to power the electrical loads at the time of the loss of the AC power and that it can be predicted that power should be available for an incremental additional time, then the system can control or regulate the startup of a generator, if present, until a later time. For example, the generator may not be powered up until a certain percent of power needs is reached, such as 80% of the available alternative energy source power and/or the potential loss of power is less than a given number of minutes, such as 30 minutes. Under such conditions, which can be varied by the operator and are only exemplary, the system can send a signal that brings the generator online to power the load or the balance of the load, while the system continues to provide DC power for at least an incremental amount of time.

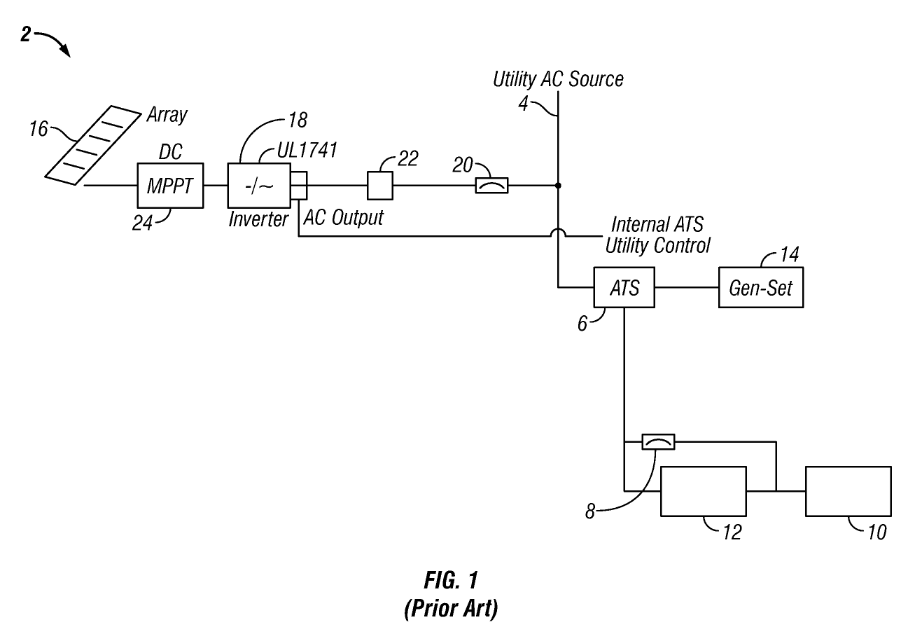

FIG. 2 is a schematic of an exemplary embodiment of the present invention having a first and second source of energy coupled to an alternative energy source, providing input downstream of a rectifier in the second source. The improved system 30 can include various components, such as an AC utility power source, automatic transfer switch (ATS), alternative energy source (AES), UPS, and electrical load as described above in FIG. 1. However, the system 30 includes the AES 16 coupled downstream of the ATS 6 from the first source of power 32, such as the utility grid. An AES output 17, generally DC, can be provided to other system components downstream of the ATS. The grid-tie inverter can be eliminated and the ATS can function to provide the safety isolation so anti-islanding issues can be avoided, and the AES can continue to provide power to the system in the event of an AC power shutdown. In at least one embodiment, the output 17 can be provided to the second source 34, such as a UPS, for conditioning prior to the electrical load.

In general, the system 30 shows that the AES 16 output is not applied to or interconnected with the first source 32. This is a significant departure from the currently accepted practice for typical systems. The AES 16 in DC power form is directed to the electrical load 10 via one or more of the flow paths described herein. Upon loss of power from the first source 32, which generally is the utility power, the ATS 6 disconnects the first source 32 from the downstream components and other sources of power. In some embodiments, if present, a generator 14 or other AC source can be engaged to provide power to the system through the ATS 6 to the downstream devices. Power from the AES 16 can continually flow, regardless of the status of the first source 32 or the generator 14. AES power can flow while the generator 14 is brought on-line and can continue to flow even while the generator 14 operates. Upon return to the normal conditions, such as when the AC utility power is again available, the ATS 6 can switch back to the first source 32. With this configuration, the downstream electrical load 10 has a more steady flow of power using the AES 16 than heretofore is believed to have been available. In at least one embodiment, the system is advantageously utilized when the AES power is less than the electrical load 10.

In more detail, the system can include a first source of power 32, generally the AC utility grid power, as a primary source of power to the system during normal operating conditions. However, other sources of “utility” power can be provided, including generating stations, such as in offshore platforms and other remote locations. Thus, the utility grid power is merely an exemplary primary source of power for the system. An output 33 from the first source of power 32 can be coupled to an ATS 6, such as described above. The ATS is primarily responsible for switching off and on the first source of power 32, when the first source is unavailable or is unacceptable to the predetermined conditions of power for the system. Such conditions can include under or over voltage, out of phase frequency, and other conditions that would render the power from the first source 32 unsuitable for the electrical load 10. Under such conditions, the electrical load needs to be provided with other sources of power to continue operation such as described herein. In some embodiments, a generator 14, such as a standby generator, can be coupled to the ATS 6. If the ATS shuts off the first source 32, and the system needs additional power, the generator can provide such power. Customarily, the generator set is a diesel or natural gas generator using fossil fuels.

An output 7 of the ATS can be coupled to a second source of power 34. In one or more embodiments, the second source of power can include an uninterruptible power supply (UPS). An uninterruptible power supply is well known in the industry and includes a variety of different embodiments, many of which have a stored energy source 36, such as a battery or large capacitor, to provide stored energy upon demand. The second source such as a UPS can condition the incoming power and help protect the electrical load 10 from transient voltage. Generally, a UPS includes a rectifier 38 to accept AC power at the input 35 of the UPS and convert the AC power into DC power. The rectifier is generally upstream of the stored energy source 36. The second source 34 further generally includes an inverter 40 disposed downstream of the rectifier 34 and the stored energy source 36. The inverter 40 creates a simulated AC power waveform from the DC power provided to it. The AC power is then delivered to the electrical load 10. Further, the stored energy source 36 can supplement or replace incoming power for a limited time.

In at least one embodiment, the AES power can be provided to an input 41 of the inverter 40. This point of input for the AES power is a radical departure from the typical system. Providing the AES power to the inverter bypasses both grid-tie inverter 18 in FIG. 1 and the rectifier 38 in FIG. 2 with the attendant increase of efficiencies. In some embodiments, the AES can provide through a controller 24 prior to providing the power to the converter 40. The controller 24 can control the power input such that it may conform to input requirements of the inverter and provide better fit to an input current waveform useful to the inverter 40, such as a maximum power point tracker (MPPT). Advantageously, the DC power from the AES 16 will be provided in such a form either directly, or through the additional and optional use of the controller 24, such as the MPPT. The controller 24 is optional and in some embodiments will not be present. In such instances, the output 17 can simply pass through a line 24A to the second source 34.

Various circuit breakers and other switches are not shown in FIG. 2 for simplicity of the circuit. However, it would be understood to those with ordinary skill in the art that various circuit breaker switches, relays and other controls would be useful to such a system. Further, various sensors and associated processors are not shown in this circuit but are described in more detail below that would send various voltage conditions, power requirements, current flow, electrical loads, as well as time, temperature and other weather conditions as might be effective in assisting the alternative energy source and power therefrom.

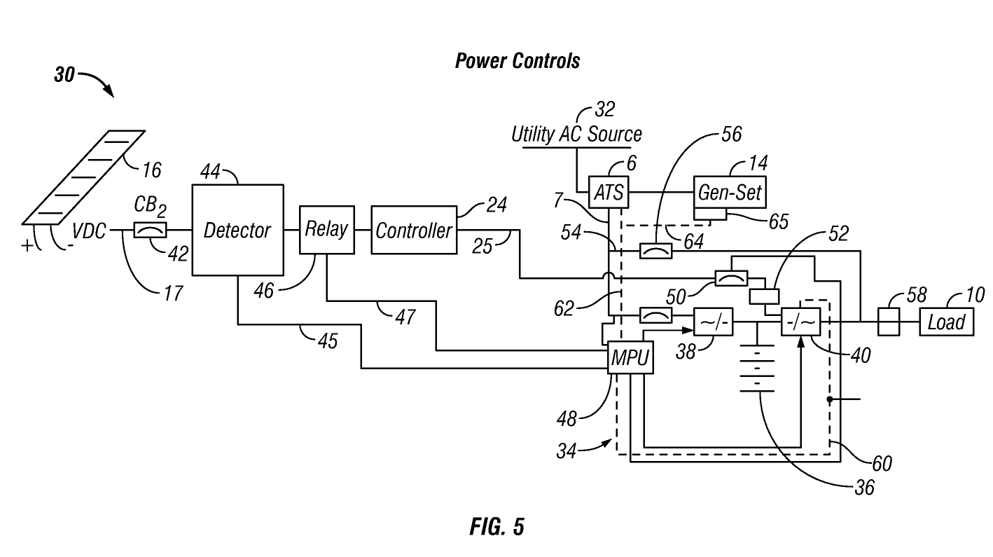

Further, a bypass (shown in FIG. 5) can be coupled from the output 7 of the ATS directly to the electrical load 10. The bypass can be used to provide the power from the first source 32 or the generator 14 to the electrical load 10 without necessitating passing the power through the second source 34. In general, for mission critical applications, it is often advantageous to pass such power through the second source 34 for at least power conditioning prior to the load 10. However, in some applications, such practice may be avoided. If the ATS 6 disconnected the first source 32 and the generator 14 is not operating at the time, then the bypass would have not power in the system, and would still depend upon the second source 34 and/or the AES 16 to continue operation.

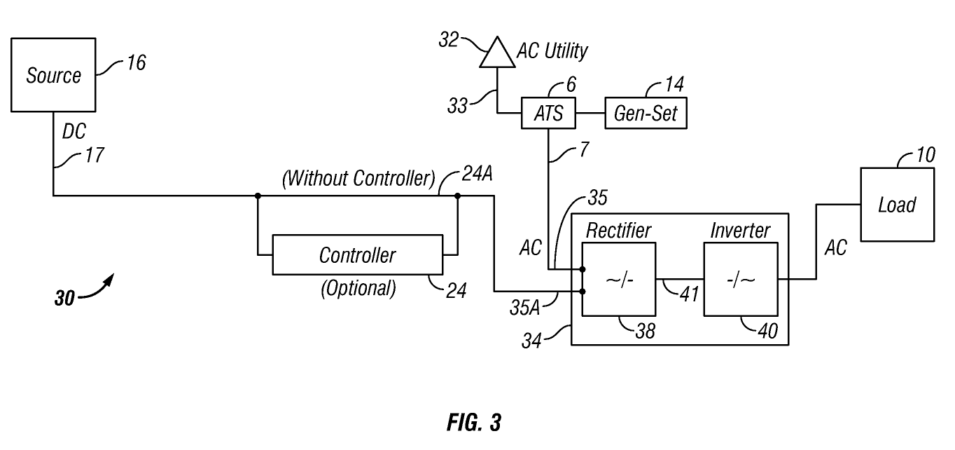

FIG. 3 is a schematic of another embodiment similar to FIG. 2 providing input to the second source of energy. In this embodiment of the system 30, similar components can be used. For example, the first source 32 and its output 33 can be coupled to the ATS 6. If provided, a generator 14 can be also coupled to the ATS 6. An ATS output 7 can be coupled to a second source 34 through an input 35 of the second source. The second source 34 can include a rectifier 38 coupled to an input 41 of the inverter 40. The inverter 40 can provide power, such as AC power, to an electrical load 10.

The AES 6 can produce DC power and the output 17 can be directed through a controller 24. In other embodiments, the output 17 can simply pass through line 24A when the control 24 is not present.

In this embodiment, the AES 16 can provide power to an input 35A of the second source 34. Since the AES source 16 is generally DC power, is it unconventional and against teaching in the art to provide DC power to an AC rectifier. However, when the ATS 6 disconnects the first source 32 (and the generator 14 is non-operational or not present), then no power would be provided to the input 35A. Power from the AES 16, as a DC power, would pass through the rectifier as a DC current into the inverter 40 for conversion to AC for the electrical load 10. Such an arrangement may be required by various statutes or regulations. The advantages of the system still are realized by coupling the AES downstream of the ATS 6, so that avoiding the grid-tie inverter can be eliminated with the resulting inefficiency and complexity of the system.

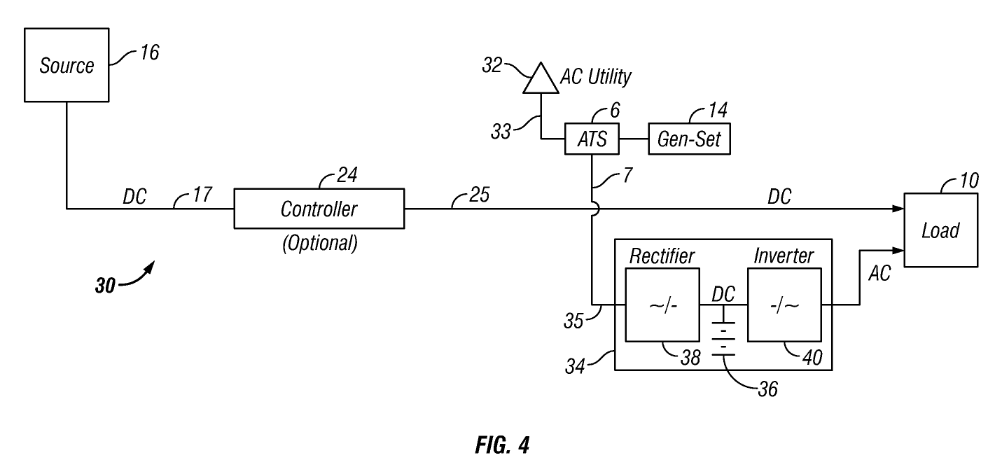

FIG. 4 is a schematic of another embodiment in which the AES 16 can provide DC power to the electrical load 10 and at least partially bypass the UPS. The rectifier and inverter are avoided and the power is provided to the load at higher efficiencies than through such components.

The system can generally include components as described above, such as a first source of power 32 providing an output 33 coupled to the ATS 6. If present, a generator 14 can be coupled to the ATS 6 and the ATS output 7 coupled to an input 35 of the second source 34. The second source 34 can include the rectifier 38, an inverter 40, and a stored energy source 36 disposed therebetween. Thus, the power from the first source 32 and/or generator 14, if present, can be provided through the ATS to the second source 34 for power conditioning and supplementation as AC power to the electrical load 10.

However, in some applications, such as a computer data center, the power is converted through components not shown from AC to DC for the specific computer equipment, such as 380 to 400 volts DC. In such applications, even higher efficiencies can be realized in the system 30 by providing the AES DC power to the electrical load without having such power pass through the second source 34 and its components with its resulting incremental loss of efficiency. As described above, an optional controller 24 can be coupled to the output 17 of the AES 16, so that the output 25 of the controller is provided to the electrical load 10, with possible safety devices such as interconnects and relays (not shown) disposed therebetween.

Having described some basic embodiments, some additional description is provided regarding various modes of operation. While the operation will be described in reference to primarily the embodiment of FIG. 2, it is expressly understood that such modes of operation are intended to be applied and adapted to other embodiments related thereto.

FIG. 5 is a schematic of the exemplary embodiment of FIG. 2 with additional details and components. It is to be understood that similar numbered elements are as shown and described above, and such details and components can be used with the other embodiments contained herein. For example, the system 30 includes the AES 16 having an output 17 that can be coupled to a controller 24. An output 25 of the controller 24 can be coupled to an inverter 40 of the second source 34. The second source 34 can further include a rectifier 38 upstream of the inverter 40 and a stored energy source 36 disposed therebetween.

The system can further include safety components and other elements. For example, the AES output 17 can be coupled to a circuit breaker 42 and a detector 44. The detector 44 can monitor voltage and/or current from the AES 16, such as the net array voltage (NAV) and/or the net available current (NAC) from one or more strings or individual components contributing to the AES power. A communication link 45 between the detector 44 and a processor 48 can be used to communicate information to the processor and instructions from the processor to the detector. For example, the detector 44 could indicate low voltage to the processor and the processor consider alternative sources of power, if the AES is unsuitable to provide power at predetermined conditions. The output 17 of the AES 16 could further be coupled to a relay 46, which can include a relay controlled circuit breaker, switch, and the like. The term “relay” is used broadly herein to include any kind of switch or semi-conductor circular device that can be used to turn off and on a particular portion of the circuit. A communication link 47 can be coupled between the relay 46 and the processor 48 to provide input from the relay to the processor and instruction from the processor to the relay. For example, if the voltage is insufficient as detected by the detector 44, the processor 48 can signal the relay 46 to close and not allow the AES power to pass therethrough.

The processor 48 can access stored data in an internal memory or external memory, such as weather, time and temperature, sunset, sunrise, and the like, that may be important to some modes of AES power generation, and other data that may be used to control various portions of the system 30. The processor 48 may be coupled to the second source 34 by being integral thereto or through various communication and power lines as an independent component from the second source. Further, the various communications conducted through the lines for control purposes, and sensing and monitoring may be performed wirelessly through receivers and transmitters. Thus, the term “control line”, “communication line,” “communication link” and the like are used broadly to include wired and wireless transmissions and communications. The processor further could also include an internal battery to maintain time and date functions after a loss of power.

The microprocessor can be programmed to open the relay 46 during known periods of zero power production by the AES 16. For example, known periods would include nighttime for a solar powered AES 16. The processor could also be programmed to open the relay during known periods of low production, such as dawn and dusk for solar panels, low winds for wind energy, low tidal movement for tidal energy, and the like. The manual override is available via an interface with the processor to open and close the relay for task repairing service. If the first source 32 is disconnected from the circuit by the ATS 6 and the AES 16 is providing power, then the processor 48 can keep the relay 46 closed, so that the DC power generated by the AES 16 can be provided to the second source 34. Such power can be used to, for example, recharge the stored energy source 36, operate at least a portion of the electrical load 10, or a combination thereof The relay 46 can be a normally open relay such that any fault of the processor 48 or wiring thereto can allow the relay to open as a default condition and disconnect the AES 16 from the circuit. A display can be provided to an operator either on site or at a remote location to indicate the condition of the system 30's operation. If a fault condition occurs, the user can be prompted to take a next action before re-engaging the processor, relay, circuit breakers, or other safety or control portions of the system 30.

In some applications, the AES 16 can provide sufficient energy to power the load 10 in absence of the first source 32. In such instances, the processor 48 can automatically isolate the first source 32 even when the power available, and use the AES 16 to provide power to the load 10.

Further, the processor 48 can control the ATS 6 through a control line 62. Further, the processor can control the operation of the generator 14 through a control line 64. For example, the first source 32 may be disconnected from the circuit by the ATS 6, and the AES source 16 and/or second source 34 may have insufficient power for the electrical load 10. The processor 48 can control the startup and shutdown of the generator 14 when the power needs are present and then are fulfilled.

A circuit breaker 50 can be disposed between the AES 16 and the inverter 40 of the second source 34. The circuit breaker can be equipped with manual override capabilities. Also, the output of the AES 16 can be further provided with a monitor 52 that can be used to detect, for example, voltage and current conditions downstream of the controller 24 prior to the inverter 40.

A main bypass 54 can be coupled between the output 7 of the ATS 6 and the load 10. The bypass 54 can be provided with a circuit breaker 56, which can be automatically or manually controlled. The bypass 54 can be used to provide power from the first source 32 to the electrical load 10 on at least a temporary basis, for example, when the second source 34 is offline. A power line 60 can be provided from the inverter 40 to the processor 48, so that the processor is powered under all normal conditions whether the first power source 32, the second power source 34, or the AES power source 16 is providing power to the second source 34. Other sources of power can be provided to the processor 48 as necessary.

Returning to the detector 44 and its function in the system, the net array voltage (NAV) and the net array current (NAC) can indicate the parameters for the voltage and current from the AES 16. To determine the current, a non-critical current path (not shown) can be provided in front of the relay 46, so that the detector 44 can function properly for detecting current and provide output to the processor 48 as described above. When the voltage and/or current at the detector are within predetermined conditions, the relay 46 can be closed to enable power flow from the AES to the downstream devices, such as the second source 34.

The second detector 52 can be placed before or after the circuit breaker 50, depending upon safety regulations, applications, legal codes, and the like. The detector 52 can compare its detected conditions with the conditions detected by the detector 44 and against known acceptable input values for the downstream devices, including the electrical load 10, the inverter 40, and other devices in the system 30. When the input values to the detector 52 are in an acceptable range, the circuit breaker 50 can be held closed to enable a flow path to the downstream devices.

In situations in which a manual override is used for the circuit breaker 50 or other circuit breakers, a communication can warn that the circuit breaker 50 has been opened but that voltage and/or current may be present. Thus, the operators or technicians may wish to check the status of the circuit breaker 42, the ATS 6, and/or a combination thereof. Further, when input values are not within the accessible range to the detector 52, the circuit breaker 50 can be opened. Such conditions can include a failed or defective controller 24, such as an MPPT, failed or defective relays, faulty wiring, failed or defective detector 44, or other fault conditions.

For one example of a type of available AES 16 power, a solar panel array can be used. In general, solar panels can be coupled in series or parallel arrangements to produce additional voltage, current, or a combination thereof. For example, the net array voltage can include “N” number of strings multiplied by the string voltage from each string when the array is set in a series of “N” strings of solar panels. Alternatively, several strings of solar panels can be coupled in parallel to produce higher current capacity from the “N” number of strings multiplied by the current capacity of each string. Naturally, different combinations of series and parallel arrangements will produce different voltages and currents.

In general, the amount of voltage and/or current generated from the solar panel is a function of the temperature, time of day, seasonal variation, cloudiness, relative sun intensity depending on the particular cleanliness of air, as well as chemistry, panel type, construction, and the number of cells for the panels. Each type of AES power has its own variables, such as wind speed and duration for wind power, tidal variation for tidal energy, and so forth. Thus, the DC will vary from such AES systems.

Under advantageous conditions, the AES power can be applied directly to the input of the inverter 40, if the inverter 40 can absorb the AES output variations. The controller 24 and/or relay 46 can control the passage of power from the AES ultimately to the inverter 40, or in general, the second source 34, or even the electrical load 10, or a combination thereof. In some instances, the controller 24, such as an MPPT, can further provide additional conditioning and/or switching of the AES power to a more suitable form for the second source 34. For example, multiple strings of solar panels can form an array to produce the AES power. The output to the multiple strings could be combined to a DC combined voltage and current. The voltage could be controlled to the inverter 40 such that the voltage provided is between a minimum voltage and maximum voltage to the inverter. For example and without limitation, the minimum voltage from the AES 16 provided to the inverter 40 could be greater than or equal to 1.1 times the minimum voltage acceptable to the inverter. Similarly, the maximum voltage that could be provided to the inverter 40 could be less than or equal to 0.9 times the maximum voltage allowable to the inverter. If the voltage is under or over predetermined conditions, then the power can be restricted or entirely disconnected from passing to the second source 34, the load 10, or a combination thereof

If the AES 16 is capable of providing power during loss of the first source 32, it is possible that the AES can have enough power for the full electrical load 10, independently or in combination with the second source 34. In such instances, the system may delay a starting of a standby generator 14, if so equipped, and at the user's option. The delay generally will not occur until certain other predetermined conditions of load, percentage of load, time, and so forth are met. The system 30 can provide the ability to monitor the electrical load, and then provide necessary signals and/or controls to start up the generator 14, shut down the generator at the appropriate time, or a combination thereof. For example, the processor 48 can monitor inputs from several sources, including the AES 16, at different points of the circuit as well as various other conditions that would affect the power output from the AES. Upon a loss of suitable voltage from the first source 32, the processor 48 should compare the total available AES power with the total required or desirable electrical load. When the total electrical load exceeds a certain predetermined condition, the generator 14 could be started. Under certain conditions, the processor 44 may determine that there is sufficient power available from the AES 16 to delay the startup of the generator. This delay may have an additional benefit of increasing the generator's useful service life. If the generators were bought on line, the AES power can remain engaged and reduce the load on the generator in some embodiments.

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. The term “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements or by wireless transmission, one or more pieces of members together and can further include without limitation integrally forming one functional member with another in a unity fashion. The coupling can occur in any direction, including rotationally.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Other and further embodiments utilizing one or more aspects of the inventions described above can be devised without departing from the spirit of Applicant's invention. Further, the various methods and embodiments of the described system can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived by the Applicants, but rather, in conformity with the patent laws, Applicants intend to fully protect all such modifications and improvements that come within the scope or range of equivalents of the following claims. Further, unless the context requires otherwise, the word “comprise” or variations such as “comprises” or “comprising”, should be understood to imply the inclusion of at least the stated element or step, or group of elements or steps, or equivalents thereof, and not the exclusion of a greater numerical quantity or any other element or step or group of elements or steps or equivalents thereof.

1. An efficient alternative energy uninterruptible power supply (UPS) system having a main first source of power coupled to an electrical load, comprising:
an uninterruptible power supply (UPS) having a rectifier, an inverter downstream of the rectifier and adapted to change a direct current (DC) to an alternating current (AC), and a battery coupled between the rectifier and the inverter, the UPS being coupled to the electrical load, to supplement the first source and condition the power from the battery to predetermined conditions for the electrical load;
an automatic transfer switch (ATS) coupled between the first source and the UPS and adapted to control the first source coupling to the electrical load when the first source power is noncompliant with predetermined conditions comprising under or over voltage and out of phase frequency conditions for the electrical load; and
a source of alternative energy coupled to an input to the inverter of the UPS, wherein the source of alternative energy comprises a source of direct current (DC) power and comprises solar energy, thermal energy, geo-thermal energy, wind energy, hydroelectric energy, fuel cell energy, biomass energy, tidal energy, or a combination thereof

2. The system of claim 1, wherein the source source of alternative energy comprises solar energy and further comprising a maximum power point tracker (MPPT) adapted to control the output of the solar energy.

3. The system of claim 1, wherein an output of the first source is coupled to the ATS and an output of the ATS is coupled to an input of the UPS, wherein the ATS is adapted to allow the UPS to provide power to the electrical load independent of the first source.

4. The system of claim 1, further comprising a generator coupled to the electrical load and adapted to provide power to the electrical load when activated.

5. The system of claim 4, further comprising a controller adapted to control an output of power from the generator depending on a sensed electrical load, an amount of power from alternative energy source, or a combination thereof.

6. The system of claim 5, wherein the controller delays startup of the generator until predetermined conditions regarding the electrical load are not satisfied by available power from the alternative energy source.

7. The system of claim 1, further comprising a controller adapted to sense an amount of power from the first source, the UPS, the alternative energy source, and control power input to the electrical load.

8. The system of claim 1, further comprising a bypass circuit coupled between the output of the ATS and the electrical load and adapted to provide the power from first source to the electrical load independent of the UPS.

9. The system of claim 1, further comprising a controller adapted to conform an output of the alternative energy source to an input waveform of the inverter of the UPS.

10. An efficient alternative energy uninterruptible power supply (UPS) system having a main first source of power coupled to an electrical load, comprising:
an uninterruptible power supply (UPS) having a rectifier, an inverter downstream of the rectifier and adapted to change a direct current (DC) to an alternating current (AC), and a battery coupled between the rectifier and the inverter, the UPS being coupled to the electrical load to supplement the first source and condition the power from the battery to predetermined conditions for the electrical load;
an automatic transfer switch (ATS) coupled between the first source and the UPS and adapted to control the first source coupling to the electrical load when the first source power is noncompliant with predetermined conditions comprising under or over voltage and out of phase frequency conditions for the electrical load; and
a source of alternative energy coupled downstream of the ATS to the UPS, the electrical load, or a combination thereof, wherein the source of alternative energy comprises a source of direct current (DC) power.

11. The system of claim 10, wherein the source of alternative energy comprises solar energy, thermal energy, geo-thermal energy, wind energy, hydroelectric energy, fuel cell energy, biomass energy, tidal energy, or a combination thereof.

12. The system of claim 10, wherein an output of the first source is coupled to the ATS and an output of the ATS is coupled to an input of the UPS, wherein the ATS is adapted to allow the UPS to provide power to the electrical load independent of the first source.

13. The system of claim 12, further comprising a standby electrical generator wherein an output of a standby electrical generator is coupled to an input of the ATS.

14. The system of claim 10, wherein the source of alternative energy comprises a solar energy source and further comprising a maximum power point tracker (MPPT) adapted to control the output of the solar energy source.

15. The system of claim 14, wherein an output of the alternative energy source is coupled between the rectifier and the inverter of the UPS.

16. The system of claim 14, wherein the alternative energy source is coupled to an input of the rectifier of the UPS.

17. The system of claim 14, wherein the alternative energy source is coupled to an input of the UPS.

18. The system of claim 10, wherein an output of the alternative energy source is coupled to the electrical load, independent of the UPS.

19. The system of claim 10, further comprising a bypass circuit coupled between the output of the ATS and the electrical load and adapted to provide the power from first source to the electrical load independent of the UPS.

20. The system of claim 10, further comprising a controller adapted to conform an output of the alternative energy source to an input waveform of the inverter of the UPS.
